(19) United States
(12) Patent Application Publication
(10) Pub. No.: US 2025/0312862 A1
(43) Pub. Date: Oct. 9, 2025

(54) ARC WELDING METHOD

(71) Applicant: Panasonic Intellectual Property Management Co., Ltd., Osaka (JP)

(72) Inventors: Junji FUJIWARA, Osaka (JP); Atsuhiro KAWAMOTO, Hyogo (JP); Koji HAMAMOTO, Hyogo (JP)

(21) Appl. No.: 19/244,548

(22) Filed: Jun. 20, 2025

Related U.S. Application Data
(63) Continuation of application No. PCT/JP2023/046158, filed on Dec. 22, 2023.

(30) Foreign Application Priority Data
Dec. 23, 2022 (JP) 2022-206680

(51) Int. Cl. B23K 9/12; B23K 9/067

(52) U.S. Cl. CPC B23K 9/12; B23K 9/067

(57) ABSTRACT

A welding period from start of welding to end of welding includes a start period and a main welding period. In the start period, a welding wire is fed at a predetermined feeding speed. In the main welding period, the welding wire is fed at a higher feeding speed than the feeding speed in the start period. The protrusion length of the welding wire at the start of welding in the start period is shorter than the protrusion length of the welding wire in the main welding period.

### CROSS-REFERENCE TO RELATED APPLICATIONS

This is a continuation of International Application No. PCT/JP2023/046158 filed on Dec. 22, 2023, which claims priority to Japanese Patent Application No. 2022-206680 filed on Dec. 23, 2022. The entire disclosures of these applications are incorporated by reference herein.

### BACKGROUND

The present invention relates to an arc welding method.

Japanese Patent No. 4499303 discloses a method for controlling arc start, in which welding is performed by moving a welding torch attached to a manipulator of a welding robot.

According to Japanese Patent No. 4499303, the welding torch is moved in a feeding direction of the welding wire at the welding start position, thereby bringing the end of the wire close to a welding target. When it is determined that the end of the wire comes into contact with the welding target, the robot moves backward, opposite to the feeding direction of the wire, to generate an arc.

### SUMMARY

As described above, in the conventional invention, the welding robot brings the welding torch closer to the welding target to cause the welding wire to come into contact with the welding target and generate an arc.

If no arc occurs instantaneously after the contact of the welding wire with the welding target, the welding wire may be deformed, causing a failure at the arc start.

To address this, it is conceivable to decrease the moving speed of the welding torch by the welding robot, which however results in a longer cycle time and a longer welding time.

The present invention was made under such circumstances. It is an object of the present invention to enable stable arc start, while reducing the deformation of a welding wire.

A first aspect is directed to an arc welding method of welding a welding target by feeding a welding wire to the welding target and generating an arc between the welding wire and the welding target, a welding period from start of welding to end of welding including a start period and a main welding period after the start period, the arc welding method comprising: feeding the welding wire at a predetermined feeding speed in the start period; generating the arc between the welding wire and the welding target after an end of the welding wire comes into contact with the welding target and a short-circuit occurs; and feeding the welding wire in the main welding period at a higher feeding speed than the feeding speed in the start period, a protrusion length of the welding wire at a point in time at which the end of the welding wire comes into contact with the welding target and a short-circuit occurs, immediately before the arc is generated at the start of welding in the start period being shorter than a protrusion length of the welding wire in the main welding period.

According to the first aspect, the protrusion length of the welding wire at the start of welding in the start period is short, thereby enabling stable arc start while reducing the deformation of the welding wire. The start period is, in other words, a transition period transitioning from the start for the arc start to the main welding period.

Setting the protrusion length of the welding wire longer in the main welding period can secure the welding amount of the welding wire.

Since it is not necessary to decrease the moving speed of the welding torch, it is possible to reduce an increase in the welding time due to a longer cycle time.

A second aspect is an embodiment of the arc welding method of the first aspect. In the second aspect, the protrusion length of the welding wire at the start of welding in the start period is 30% to 80% of the protrusion length of the welding wire in the main welding period.

According to the second aspect, the protrusion length of the welding wire at the start of welding in the start period is properly set, thereby making it possible to achieve both the stability of the arc start and the sufficient welding amount of the welding wire.

A third aspect is an embodiment of the arc welding method of the first or second aspect. In the third aspect, the welding period includes an end period after the main welding period, and the protrusion length of the welding wire at the end of welding in the end period is equal to or shorter than the protrusion length of the welding wire at the start of welding in the start period.

According to the third aspect, the protrusion length of the welding wire after the end of welding in the end period is set short, thereby making it possible to reduce problems, such as touch start, at the start of the next welding.

A fourth aspect is an embodiment of the arc welding method of the first or second aspect. In the fourth aspect, the welding period includes an end period after the main welding period, the arc welding method further comprising: feeding the welding wire so that the protrusion length of the welding wire at the end of welding in the end period is equal to the protrusion length of the welding wire in the main welding period; and feeding the welding wire backward after end of the end period so that the protrusion length of the welding wire is equal to or shorter than the protrusion length of the welding wire at the start of welding in the start period.

According to the fourth aspect, setting the protrusion length of the welding wire to be short by feeding the welding wire backward after the end of welding in the end period can reduce problems, such as touch start, at the start of the next welding.

A fifth aspect is an embodiment of the arc welding method of the first or second aspect. In the fifth aspect, the welding target is made of a mild steel material or a material having a higher electrical resistance than a mild steel material.

According to the fifth aspect, even if the welding target is a mild steel material or a material having a higher electrical resistance than a mild steel material, the welding amount of the welding wire can be secured by setting the protrusion length of the welding wire longer in the main welding period.

A sixth aspect is an embodiment of the arc welding method of the first or second aspect. In the sixth aspect, the protrusion length of the welding wire at the point in time at which the end of the welding wire comes into contact with the welding target and a short-circuit occurs, immediately before the arc is generated at the start of welding in the start period is shorter than the protrusion length of the welding wire in a transition period that is a period of transition from the start period to the main welding period and in which a feeding speed or an average feeding speed increases.

According to the sixth aspect, it is possible to increase the welding amount of the welding wire and secure a stable, large welding amount by setting the protrusion length of the welding wire in the main welding period, in which the weld pool is formed and the molten state is stable, longer than the protrusion length of the welding wire at the start of welding (the point in time when the end of the welding wire comes into contact with the welding target and a short-circuit occurs) in the start period.

Further, by gradually increasing the protrusion length of the welding wire in the transition period (the start period) that is a period of transition from the start period to the main welding period and in which a feeding speed or an average feeding speed increases, the welding amount of the welding wire from before the main welding period is increased smoothly. It is thus possible to secure a stable, large welding amount and secure a stable, large welding amount from the start of the main welding period more reliably.

The aspects of the present disclosure enable stable arc start, while reducing the deformation of a welding wire.

### BRIEF DESCRIPTION OF THE DRAWINGS

FIG. 1 is a diagram illustrating a schematic configuration of an arc welding device according to an embodiment.

FIG. 2 is a diagram illustrating a current, a voltage, the waveform of a feeding speed, a protrusion length, and a teaching point in pulse welding.

FIG. 3 is a diagram illustrating a current, a voltage, the waveform of a feeding speed, a protrusion length, and a teaching point at the time of an arc start failure.

FIG. 4 is a diagram illustrating an example arc start failure.

FIG. 5 is a diagram illustrating a current, a voltage, the waveform of a feeding speed, a protrusion length, and a teaching point in pulse welding according to a first variation.

FIG. 6 is a diagram illustrating a current, a voltage, the waveform of a feeding speed, a protrusion length, and a teaching point in pulse welding according to a second variation.

FIG. 7 is a diagram illustrating a current, a voltage, the waveform of a feeding speed, a protrusion length, and a teaching point in pulse welding according to a third variation.

FIG. 8 is a diagram illustrating a current, a voltage, the waveform of a feeding speed, a protrusion length, and a teaching point in pulse welding according to a fourth variation.

FIG. 9 is a diagram illustrating a current, a voltage, the waveform of a feeding speed, a protrusion length, and a teaching point in short-circuit welding according to a fifth variation.

FIG. 10 is a diagram illustrating a current, a voltage, the waveform of a feeding speed, a protrusion length, and a teaching point in short-circuit welding under forward/backward feeding control according to a sixth variation.

### DETAILED DESCRIPTION

An embodiment of the present invention will be described below with reference to the drawings. The following description of the embodiment is merely an example in nature, and is not intended to limit the scope, applications, or use of the present invention.

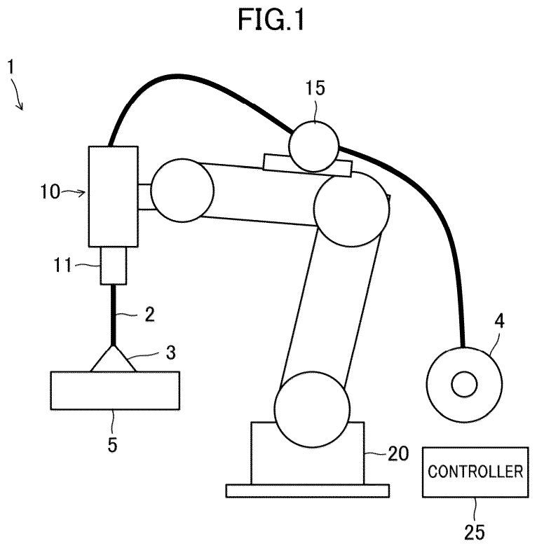

As shown in FIG. 1, an arc welding device 1 welds a welding target 5 by generating an arc 3 between a welding wire 2, which is a consumable electrode, and the welding target 5. The welding target 5 is made of a mild steel material or a material (e.g., stainless steel material) having a higher electrical resistance than the mild steel material.

The welding wire 2 is wound around a wire reel 4. Preferably, the cast diameter as a free diameter of the welding wire 2 drawn out from the wire reel 4 (i.e., the diameter as a free diameter of the spread welding wire 2 when the welding wire 2 is cut into two or three turns and placed on a plane without constraint) is set to φ 2000 mm or more by placing a wire straightening device, not shown (a device for straightening the curvature of the wire, the bending habit of the wire which is the wire habit of the welding wire 2, to a constant state) in the feeding path and adjusting the diameter. This can reduce the bending habit of the welding wire 2 and displacement of the end of the welding wire 2 protruding beyond a chip 11 attached to a welding torch 10 from the target position on the welding target 5.

The arc welding device 1 includes the welding torch 10, a wire feeder 15, a robot 20, a controller 25, and a power supply (not shown). The chip 11 is provided at the distal end of the welding torch 10. The chip 11 supplies power to the welding wire 2.

The wire feeder 15 feeds the welding wire 2 at a predetermined feeding speed, based on a signal from the controller 25. In addition, the wire feeder 15 can alternate forward feeding of the welding wire 2 toward the welding target 5 and backward feeding of the welding wire 2 opposite to the forward feeding, based on the signal from the controller 25.

The robot 20 includes a plurality of joints. The welding torch 10 is attached to the distal end of the robot 20. The robot 20 moves the position of the welding torch 10 with respect to the welding target 5.

The controller 25 controls the operations of the robot 20 and the wire feeder 15. The controller 25 moves the welding torch 10 in the welding direction of the welding target 5 by giving a current command to a motor (not shown) of each axis of the robot 20.

The controller 25 controls the feeding speed of the welding wire 2 in accordance with a set current of a welding current that is preset. Here, the feeding speed and the welding current are correlated with each other. More specifically, there is a correlation between the average welding speed (also referred to as the amount of feeding) as a moving average and the average welding current (also referred to as a set current) that is an average current as a moving average.

### <Method of Controlling Arc Welding Device>

Next, an operation of the arc welding device 1 will be described. The arc welding device 1 supplies a current between the welding wire 2 and the welding target 5. Accordingly, an arc 3 occurs between the welding wire 2 and the welding target 5. The heat of the arc 3 melts the end of the welding wire 2 and part of the welding target 5. The melted welding wire 2 turns into a droplet, which drops onto the welding target 5 and forms a weld pool together with the part of the welding target 5 melted by the heat of the arc 3.

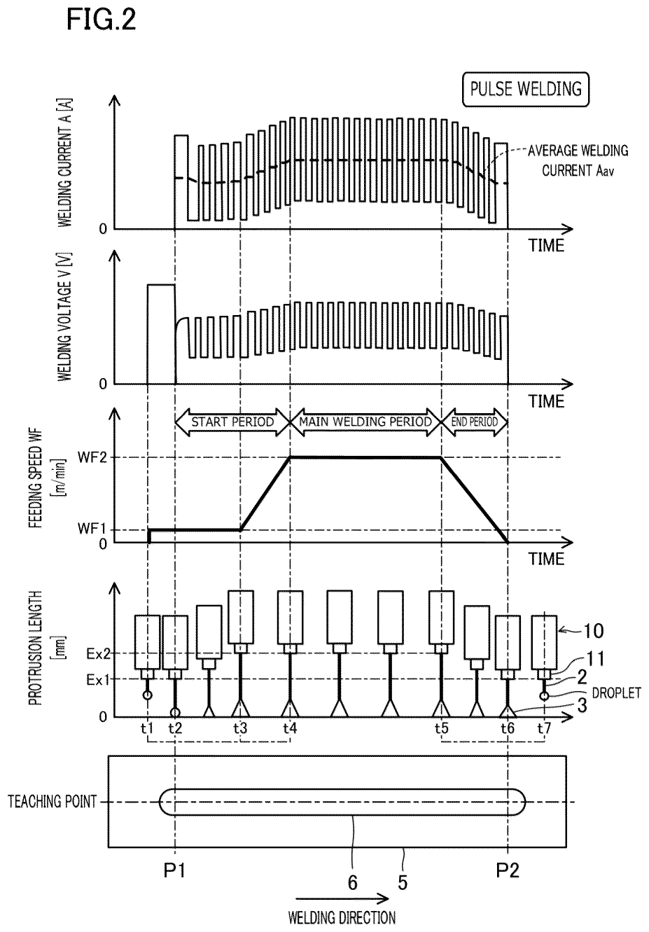

The welding torch 10 moves along the welding direction of the welding target 5. Beads 6 (see FIG. 2) are formed on the welding target 5 along with the movement of the welding torch 10, and the welding target 5 is welded.

FIG. 2 is a diagram illustrating a current, a voltage, the waveform of a feeding speed, a protrusion length, and a teaching point in pulse welding. With respect to the waveform of FIG. 2, the vertical axis represents the welding current A, the welding voltage V, and the feeding speed WF, while the horizontal axis represents time.

The arc welding device 1 applies the welding current A and the welding voltage V to the welding wire 2. The pulse waveform of the welding current A is a pulse-like waveform, and includes a peak current period, in which the welding current A is a peak current, and a base current period, in which the welding current A is a base current.

The peak current and the base current may change in accordance with the switching of the pulse. Specifically, the feeding speed WF and the welding current A are correlated with each other, and the peak current and the base current of the welding current A change at the switching of the pulse, in accordance with the change in the feeding speed WF. In other words, the peak current and the base current of the welding current A change at the switching of the pulse, in accordance with the average welding current Aav as an average welding current (also referred to as a “set current”) that is an average current as a moving average.

As will be described later, the feeding speed WF of the welding wire 2 is set based on the magnitude of the average welding current Aav as the average welding current.

In pulse welding, a periodic droplet transfer state is obtainable by periodically alternating a peak current period and a base current period at a predetermined pulse frequency. In the pulse welding, for example, an average welding current Aav of 200 A is applied to the welding wire 2, as the average welding current (also referred to as the “set current”) that is an average current as the moving average.

The arc welding device 1 sets the feeding speed of the welding wire 2, based on the set magnitude of the average welding current Aav as the moving average. Various pulse parameters constituting the DC pulse waveform are set based on the feeding speed of the welding wire 2.

A welding start point P1 and a welding end point P2 are set for the welding target 5. The arc welding device 1 performs pulse welding, while moving the welding torch 10 in the welding direction from the welding start point P1 to the welding end point P2 in the welding period from the start of welding to the end of welding.

In FIG. 2, t1 represents the point in time at which the feeding operation of the welding wire 2 is started. The feeding operation of the welding wire 2 from the time point t1 to a time point t4 is performed while the movement of the welding torch 10 in the welding direction is stopped and the welding torch 10 is kept standby at the welding start point P1.

In other words, the feeding operation of the welding wire 2 in the period from the time point t1 to a time point t2, and the feeding operation of the welding wire 2 in the period from the time point t2 to the time point t4, which is the start period described later, are performed while the movement of the welding torch 10 in the welding direction is kept standby at the welding start point P1. From the time point t1 to the time point t2, the welding wire 2 is fed constantly at a first feeding speed WF1.

The welding period includes a start period, a main welding period, and an end period. The start period is a period from the start of welding until the formation of a weld pool in the welding target 5, at the welding start point P1 of the welding target 5. The start period is, in other words, a transition period transitioning from the start for the arc start to the main welding period.

The start period is a period from the time point t2 to the time point t4. The time point t2 represents the point in time at which the end of the welding wire 2 comes into contact with the welding target 5, causing a short-circuit. From the time point t2 to a time point t3, an arc 3 is generated between the welding wire 2 and the welding target 5, and the welding wire 2 is fed constantly at the first feeding speed WF1.

From the time point t3 to the time point t4, the feeding speed of the welding wire 2 is gradually increased from the first feeding speed WF1 toward a second feeding speed WF2. The second feeding speed WF2 is higher than the first feeding speed WF1. At the time point t4, after the feeding speed of the welding wire 2 has reached the second feeding speed WF2, the period transitions from the start period to the main welding period.

The main welding period is a period from the time point t4 to a time point t5. In the main welding period, the pulse welding is performed while the robot 20 moves the welding torch 10 in the welding direction from the welding start point P1 to the welding end point P2 of the welding target 5. In the main welding period, the welding wire 2 is fed constantly at the second feeding speed WF2. At the time point t5, after the welding torch 10 moves to the welding end point P2, the period transitions from the main welding period to the end period.

The end period is a period from the time point t5 to a time point t6. The feeding operation of the welding wire 2 from the time point t5 to the time point t6 is performed while the movement of the welding torch 10 in the welding direction is stopped and the welding torch 10 is kept standby at the welding end point P2.

The end period is a period until the end of the feeding of the welding wire 2 at the welding end point P2 of the welding target 5. Specifically, from the time point t5 to the time point t6, the feeding speed of the welding wire 2 is gradually decreased from the second feeding speed WF2 to zero. From the time point t6 to a time point t7, the feeding operation of the welding wire 2 is stopped, resulting in a short protrusion length of the welding wire 2 at the time point t7.

### <Arc Start>

In the start period, if no arc occurs instantaneously after the welding wire 2 comes into contact with the welding target 5, deformation of the welding wire 2 may occur, causing a failure at the arc start.

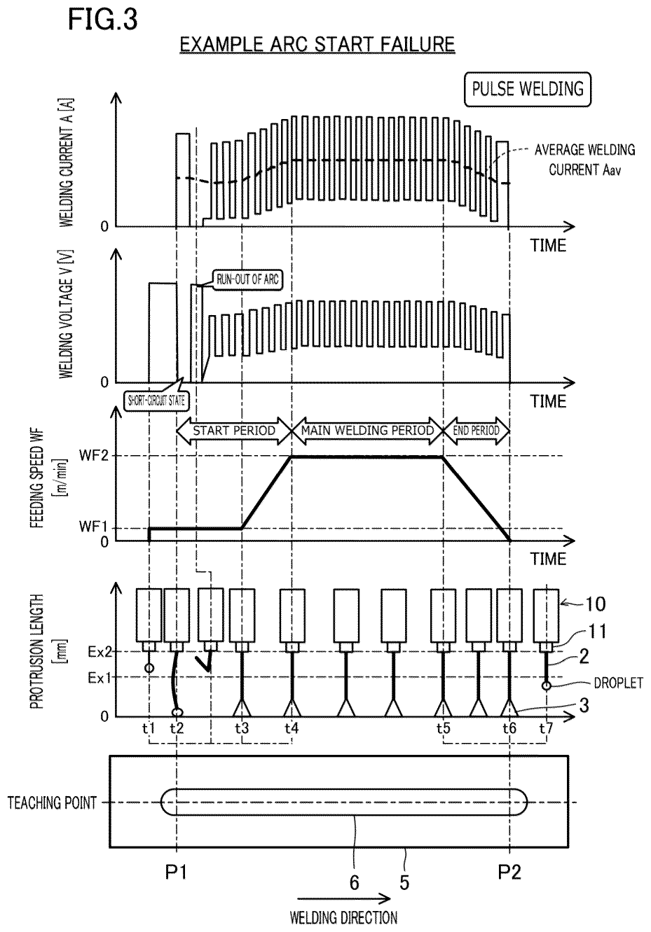

Specifically, the following case will be studied: as shown in FIG. 3, the distance between the tip of the chip 11 of the welding torch 10 and a surface of the welding target 5 (i.e., the surface of the welding target 5 facing the chip 11) is made constant in the start period (t2 to t4), the main welding period (t4 to t5), and the end period (t5 to t6), thereby making a protrusion length of the welding wire 2, which is the length of the protrusion of the welding wire 2 from the tip of the chip 11, a long protrusion length Ex2, e.g., 25 mm.

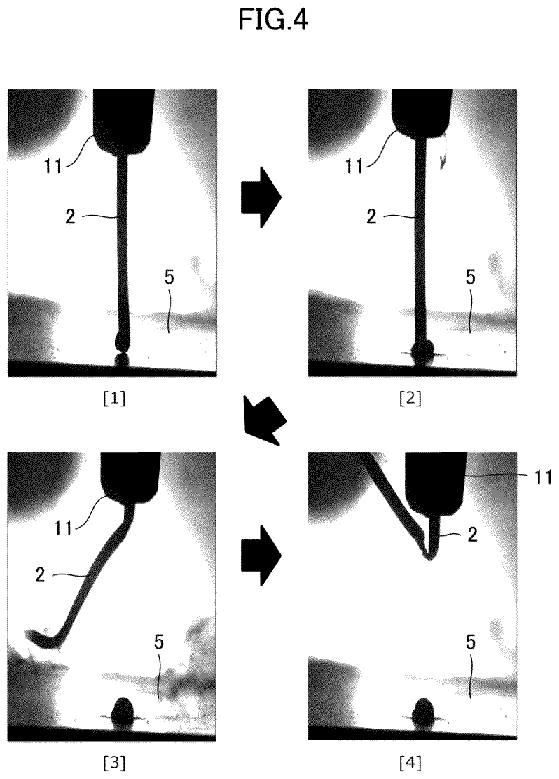

As shown in FIG. 4, if the end of the welding wire 2 with a long protrusion length comes into contact with the welding target 5 (the time point t2 when the end of the welding wire 2 comes into contact with the welding target 5 in FIG. 3) (the state shown in [1]), and no arc occurs thereafter and results in a short-circuit state (the state shown in [2]), a large current flows through the welding wire 2 because the welding wire 2 has a relatively high resistance due to a long protrusion length; and a larger amount of heat (i.e., red heat) is generated, which softens and deforms the welding wire 2. In this case, the welding wire 2 with a long protrusion length is fused and blown off (the state shown in [3]). As a result, run-out of the arc occurs, causing an arc start failure (the state shown in [4]).

To address this, in this embodiment, the protrusion length Ex1 of the welding wire 2 at the start of welding (the time point t2 when the end of the welding wire 2 comes into contact with the welding target 5, and a short-circuit occurs) in the start period is made shorter than the protrusion length Ex2 of the welding wire 2 in the main welding period (Ex1<Ex2). In other words, the protrusion length Ex1 of the welding wire 2 at the start of welding (the time point t2 when the end of the welding wire 2 comes into contact with the welding target 5, and a short-circuit occurs) in the start period is made shorter than the protrusion length Ex2 of the welding wire 2 in the main welding period.

Specifically, as shown in FIG. 2, the arc welding device 1 causes the robot 20 to move the welding torch 10 up and down, thereby adjusting the distance between the tip of the chip 11 of the welding torch 10 and the surface of the welding target 5 (the surface of the welding target 5 facing the chip 11). The protrusion length of the welding wire 2 is determined by this distance.

Here, the protrusion length of the welding wire 2 at the point in time when the end of the welding wire 2 comes into contact with the welding target 5, and a short-circuit occurs, immediately before the generation of the arc at the start of welding in the start period, is referred to as a first protrusion length Ex1. The protrusion length of the welding wire 2 in the main welding period is referred to as a second protrusion length Ex2.

In this embodiment, the height of the welding torch 10 is adjusted so that the first protrusion length Ex1 is shorter than the second protrusion length Ex2. For example, if the welding wire 2 has a wire diameter of q 1.2 mm, the first protrusion length Ex1 is set to 15 mm and the second protrusion length Ex2 is set to 25 mm. The first protrusion length Ex1 in the start period may be changed as appropriate in accordance with the wire diameter of the welding wire 2.

The first protrusion length Ex1 of the welding wire 2 at the start of welding in the start period is preferably 30% to 80% of the second protrusion length Ex2 of the welding wire 2 in the main welding period.

For example, if the welding wire 2 has a wire diameter of @ 1.2 mm, the second protrusion length Ex2 in the main welding period is set to 20 mm to 30 mm; the first protrusion length Ex1 in the start period is set to 12 mm to 15 mm; and the protrusion length ratio Ex1/Ex2 in the start period is set to 40% to 75%.

In the start period, from the time point t2 to the time point t3, the welding wire 2 is fed constantly at the first feeding speed WF1 at the welding start point P1. In this period, the welding torch 10 is gradually ascended to increase the distance from the surface of the welding target 5, so that the protrusion length of the welding wire 2 is gradually increased from the first protrusion length Ex1 to the second protrusion length Ex2.

At the time point t3, the protrusion length of the welding wire 2 reaches the second protrusion length Ex2, which is longer (greater) than the first protrusion length Ex1. From the time point t3 to the time point t4, the feeding speed of the welding wire 2 is gradually increased from the first feeding speed WF1 toward the second feeding speed WF2, and the period transitions to the main welding period. In this period, the protrusion length of the welding wire 2 is constant at the second protrusion length Ex2.

Here, the protrusion length of the welding wire 2 at the point in time when the end of the welding wire 2 comes into contact with the welding target 5, and a short-circuit occurs, immediately before the generation of an arc at the start of welding in the start period is shorter than the protrusion length of the welding wire 2 in the transition period that is a period of transition from the start period to the main welding period and in which the feeding speed increases.

In the main welding period, from the time point t4 to the time point t5, the welding torch 10 is moved in the welding direction from the welding start point P1 to the welding end point P2, with the welding torch 10 kept at a constant height, and the period transitions to the end period. In this period, the protrusion length of the welding wire 2 is constant at the second protrusion length Ex2, and the feeding speed of the welding wire 2 is constant at the second feeding speed WF2.

In the end period, at the welding end point P2, the feeding speed of the welding wire 2 is gradually decreased from the second feeding speed WF2 to zero from the time point t5 to the time point t6. In this period, the welding torch 10 is gradually descended to reduce the distance from the surface of the welding target 5, so that the protrusion length of the welding wire 2 is gradually reduced from the second protrusion length Ex2 to the first protrusion length Ex1 or shorter.

From the time point t6 to the time point t7, the feeding operation of the welding wire 2 is stopped, with the height of the welding torch 10 kept constant. The protrusion length of the welding wire 2 at the time point t7 is therefore shortened.

Accordingly, the protrusion length of the welding wire 2 at the end of welding in the end period is shorter than the protrusion length of the welding wire 2 in the main welding period, and equal to or shorter than the protrusion length of the welding wire 2 at the start of welding in the start period. For example, if the first protrusion length Ex1 as the protrusion length of the welding wire 2 at the start of welding in the start period is 15 mm, the protrusion length of the welding wire 2 at the end of welding in the end period is also 15 mm. The protrusion length of the welding wire 2 at the end of welding in the end period may be reduced to 5 mm.

As described above, according to the arc welding method of this embodiment, the protrusion length of the welding wire 2 at the start of welding in the start period is shorter than the protrusion length of the welding wire 2 in the main welding period, and equal to or shorter than the protrusion length of the welding wire 2 at the start of welding in the start period. This configuration enables stable arc start, while reducing the deformation of the welding wire 2. Setting the protrusion length of the welding wire 2 longer in the main welding period can secure the welding amount of the welding wire 2.

By properly setting the protrusion length of the welding wire 2 at the start of welding in the start period shorter than the protrusion length of the welding wire 2 in the main welding period, the resistance in the protrusion length of the welding wire 2 can be relatively lowered, enabling a reduction in deformation of the welding wire. It is thus possible to achieve both the stability of the arc start and the sufficient welding amount of the welding wire 2.

Even if the welding target 5 is a mild steel material or a material having a higher electrical resistance than a mild steel material, it is possible to increase the welding amount of the welding wire 2 and secure a stable, large welding amount by setting the protrusion length of the welding wire 2 in the main welding period, in which the weld pool is formed and the molten state is stable, longer than the protrusion length of the welding wire 2 at the start of welding in the start period.

Further, the protrusion of the welding wire 2 from the chip 11 can be set to a proper protrusion length by setting the protrusion length of the welding wire 2 after the end of welding in the end period shorter than the protrusion length of the welding wire 2 in the main welding period, and equal to or shorter than the protrusion length of the welding wire 2 at the start of welding in the start period. This configuration can reduce problems, such as touch start, at the start of the next welding.

Further, it is possible to increase the welding amount of the welding wire 2 and secure a stable, large welding amount by setting the protrusion length of the welding wire 2 in the main welding period, in which the weld pool is formed and the molten state is stable, longer than the protrusion length of the welding wire 2 at the start of welding (the point in time when the end of the welding wire 2 comes into contact with the welding target 5, and a short-circuit occurs) in the start period.

Moreover, by gradually increasing the protrusion length of the welding wire 2 in the transition period (the start period) that is a period of transition from the start period to the main welding period and in which the feeding speed increases, the welding amount of the welding wire 2 from before the main welding period is increased smoothly. It is thus possible to secure a stable, large welding amount and secure a stable, large welding amount from the start of the main welding period more reliably.

### First Variation

In the following description, the same reference characters designate the same components as those of the above embodiment, and the description is focused only on the differences between this variation and the above embodiment.

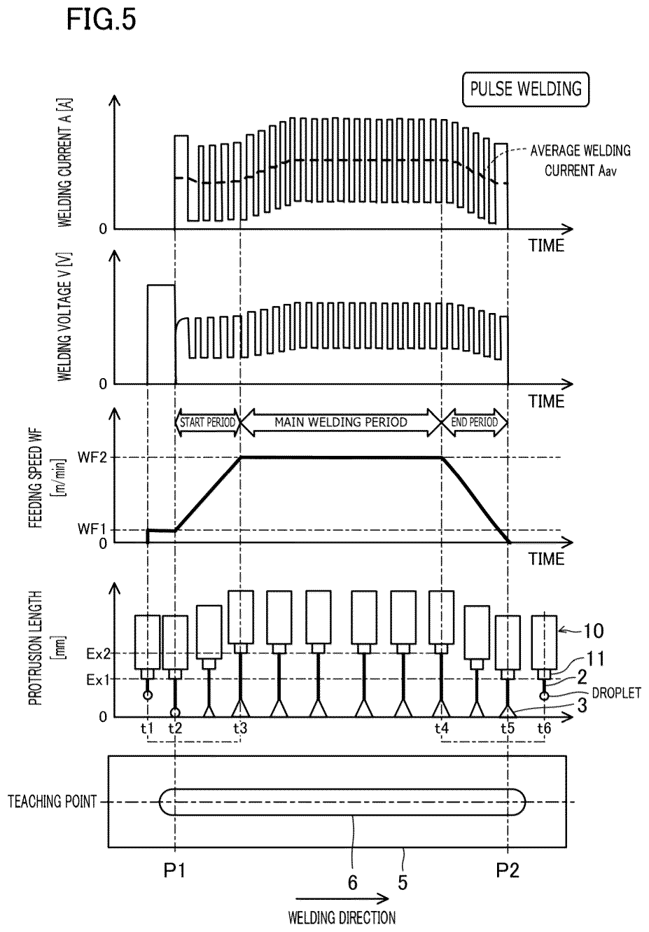

As shown in FIG. 5, t1 represents the point in time at which the feeding operation of the welding wire 2 is started. The feeding operation of the welding wire 2 from the time point t1 to the time point t3 is performed while the welding torch 10 is kept standby at the welding start point P1 in the welding direction. From the time point t1 to the time point t2, the welding wire 2 is fed constantly at a first feeding speed WF1.

The start period is a period from the time point t2 to the time point t3. The time point t2 represents the point in time at which the end of the welding wire 2 comes into contact with the welding target 5, causing a short-circuit. From the time point t2 to the time point t3, an arc 3 is generated between the welding wire 2 and the welding target 5, and the feeding speed of the welding wire 2 is gradually increased from the first feeding speed WF1 toward the second feeding speed WF2.

In this period, the welding torch 10 is gradually ascended to increase the distance from the surface of the welding target 5, so that the protrusion length of the welding wire 2 is gradually increased from the first protrusion length Ex1 to the second protrusion length Ex2. At the time point t3, after the feeding speed of the welding wire 2 has reached the second feeding speed WF2, the period transitions from the start period to the main welding period.

In this manner, in the start period, the feeding speed of the welding wire 2 is increased immediately after the welding wire 2 at the start of welding has come into contact with the welding target 5 and a short-circuit occurs (the time point t2 when the end of the welding wire 2 comes into contact with the welding target 5, and a short-circuit occurs), and the protrusion length of the welding wire 2 is increased to be longer than the protrusion length of the welding wire 2 at the start of welding in the start period (the time point t2 when the end of the welding wire 2 comes into contact with the welding target 5, and a short-circuit occurs), thereby making it possible to shorten the cycle time in the start period and shorten the welding time stably as a whole.

In the example shown in FIG. 5, the main welding period is a period from the time point t3 to the time point t4. The end period is a period from the time point t4 to the time point t5. The time point t6 indicates a state in which the protrusion length of the welding wire 2 is shortened after the end period.

The operation of the arc welding device 1 in the main welding period and the end period is the same as that in the above embodiment. The description thereof will thus be omitted.

### Second Variation

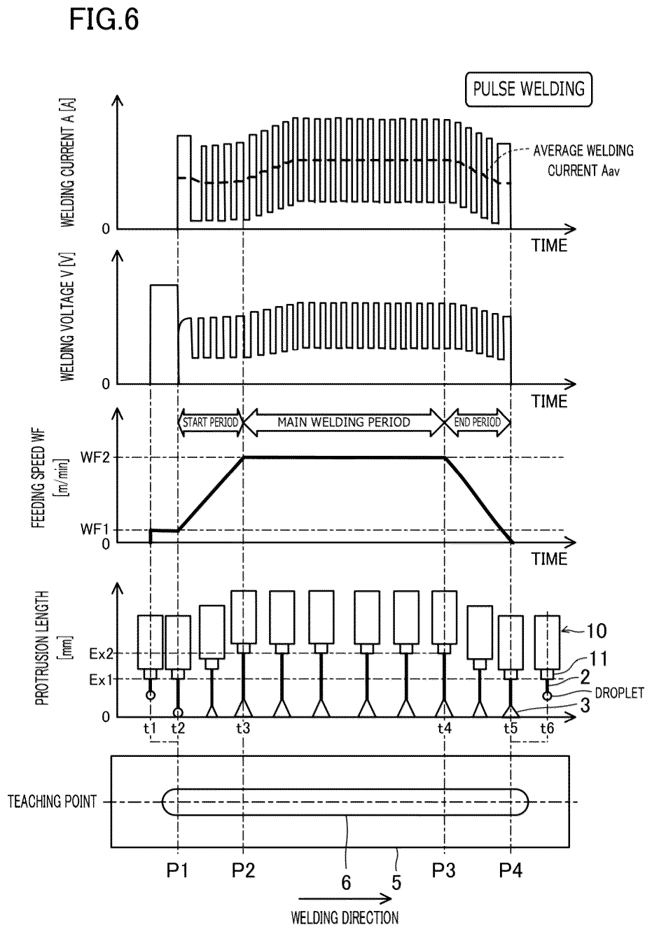

In the example shown in FIG. 6, P1 represents the welding start point and P4 represents the welding end point. A teaching point P2 is set at a position away from the welding start point P1 toward the downstream side in a forward direction of the welding. A teaching point P3 is set at a position away from the welding end point P4 toward the upstream side in a direction opposite to the forward direction of the welding.

The time point t1 represents the point in time at which the feeding operation of the welding wire 2 is started. The feeding operation of the welding wire 2 from the time point t1 to the time point t2 is performed while the welding torch 10 is kept standby at the welding start point P1 in the welding direction. From the time point t1 to the time point t2, the welding wire 2 is fed constantly toward the welding target 5 at the first feeding speed WF1.

The start period is a period from the time point t2 to the time point t3. The welding torch 10 starts moving in the welding direction in the start period. The time point t2 represents the point in time at which the end of the welding wire 2 comes into contact with the welding target 5, causing a short-circuit. From the time point t2 to the time point t3, an arc 3 is generated between the welding wire 2 and the welding target 5, and the feeding speed of the welding wire 2 is gradually increased from the first feeding speed WF1 toward the second feeding speed WF2. At the time point t3, after the feeding speed of the welding wire 2 has reached the second feeding speed WF2, the period transitions from the start period to the main welding period.

In the start period, the welding torch 10 is gradually ascended to increase the distance from the surface of the welding target 5, so that the protrusion length of the welding wire 2 is gradually increased from the first protrusion length Ex1 to the second protrusion length Ex2. In the start period, the pulse welding is performed by moving the welding torch 10 in the welding direction from the welding start point P1 toward the teaching point P2 (the point of transition from the start period to the main welding period).

The main welding period is a period from the time point t3 to a time point t4. In the main welding period, from the time point t3 to the time point t4, the pulse welding is performed by moving the welding torch 10 in the welding direction from the teaching point P2 to the teaching point P3 (the point of transition from the main welding period to the end period), with the height of the welding torch 10 kept constant. The period then transitions to the end period. In this main welding period, the protrusion length of the welding wire 2 is constant at the second protrusion length Ex2, and the feeding speed of the welding wire 2 is constant at the second feeding speed WF2.

The end period is a period from the time point t4 to the time point t5. In the end period, the pulse welding is performed by moving the welding torch 10 in the welding direction from the teaching point P3 to the welding end point P4. In the end period, the feeding speed of the welding wire 2 is gradually decreased from the second feeding speed WF2 to zero. In the end period, the welding torch 10 is gradually descended to reduce the distance from the surface of the welding target 5, so that the protrusion length of the welding wire 2 is gradually reduced from the second protrusion length Ex2 to the first protrusion length Ex1 or shorter.

In this manner, the welding torch 10 is moved in the welding direction from the welding start point P1 to the teaching point P2 in the start period, and the welding torch 10 is moved in the welding direction from the teaching point P3 to the welding end point P4 in the end period, thereby making it possible to shorten the standby time at the welding start point P1 and the welding end point P4 and relatively shorten the welding time as a whole.

### Third Variation

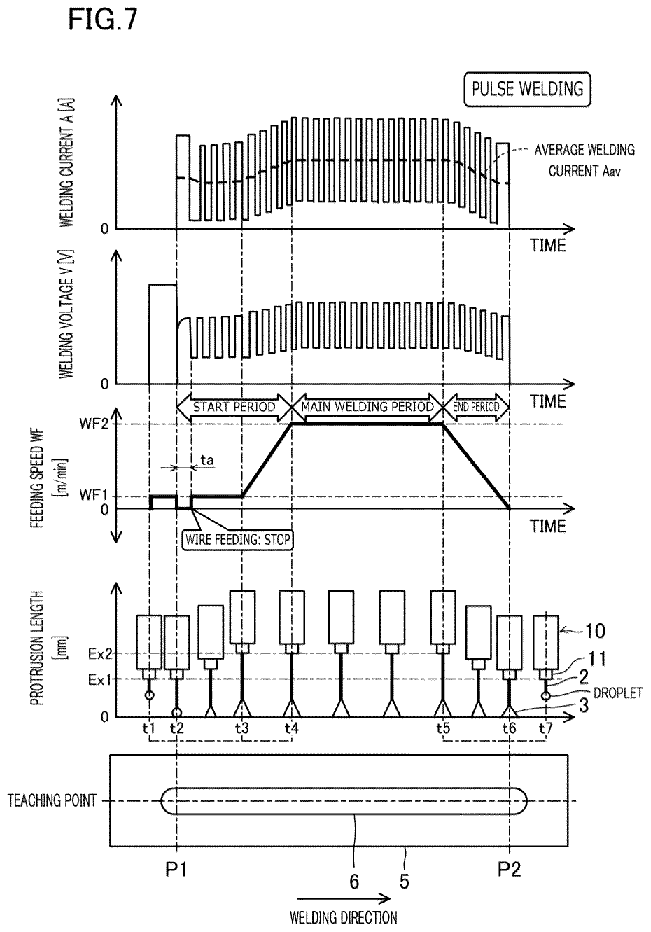

As shown in FIG. 7, from the time point t1 to the time point t2, the welding wire 2 is fed constantly toward the welding target 5 at the first feeding speed WF1.

The start period is a period from the time point t2 to the time point t4. For a predetermined time ta from the time point t2, the feeding operation of the welding wire 2 is stopped. After that, until the time point t3, the welding wire 2 is fed constantly at the first feeding speed WF1.

In the period from the time point t2 to the time point t3, the welding torch 10 is gradually ascended to increase the distance from the surface of the welding target 5, so that the protrusion length of the welding wire 2 is gradually increased from the first protrusion length Ex1 to the second protrusion length Ex2.

At the time point t3, the protrusion length of the welding wire 2 is the second protrusion length Ex2. From the time point t3 to the time point t4, the feeding speed of the welding wire 2 is gradually increased from the first feeding speed WF1 toward the second feeding speed WF2, and the period transitions to the main welding period. In this period (from the time point t3 to the time point t4), the protrusion length of the welding wire 2 is constant at the second protrusion length Ex2.

The operation of the arc welding device 1 in the main welding period and the end period is the same as that in the above embodiment. The description thereof will thus be omitted.

In this manner, at the arc start time, the feeding operation of the welding wire 2 is temporarily stopped to reduce the deformation of the welding wire 2 due to softening, thereby making it possible to reduce fusing.

### Fourth Variation

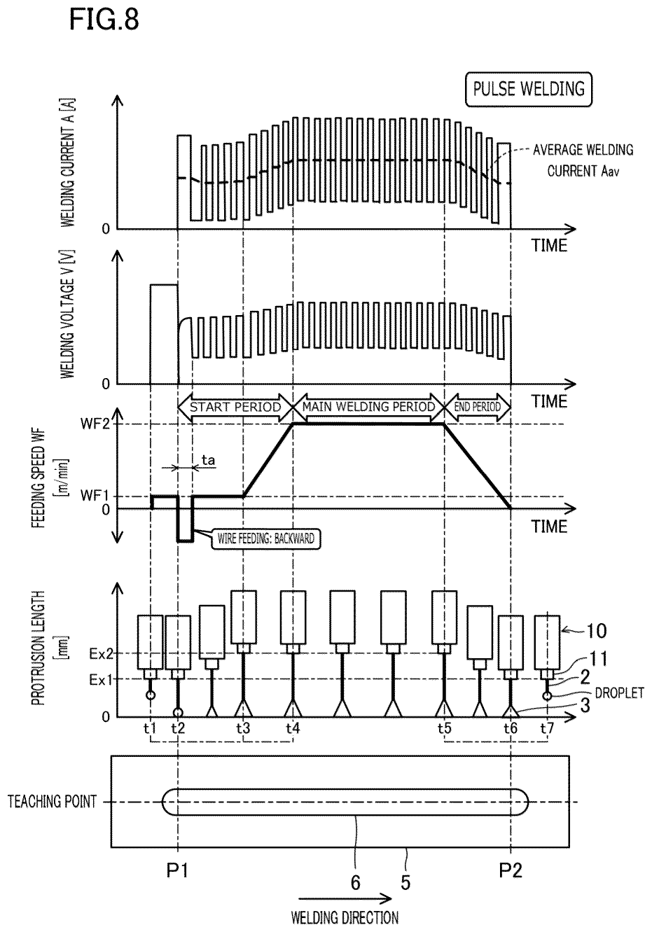

As shown in FIG. 8, from the time point t1 to the time point t2, the welding wire 2 is fed constantly toward the welding target 5 at the first feeding speed WF1.

The start period is a period from the time point t2 to the time point t4. For a predetermined time ta from the time point t2, the welding wire 2 is fed backward. After that, until the time point t3, the welding wire 2 is fed constantly at the first feeding speed WF1.

In the period from the time point t2 to the time point t3, the welding torch 10 is gradually ascended to increase the distance from the surface of the welding target 5, so that the protrusion length of the welding wire 2 is gradually increased from the first protrusion length Ex1 to the second protrusion length Ex2.

At the time point t3, the protrusion length of the welding wire 2 is the second protrusion length Ex2. From the time point t3 to the time point t4, the feeding speed of the welding wire 2 is gradually increased from the first feeding speed WF1 toward the second feeding speed WF2, and the period transitions to the main welding period. In this period (from the time point t3 to the time point t4), the protrusion length of the welding wire 2 is constant at the second protrusion length Ex2.

The operation of the arc welding device 1 in the main welding period and the end period is the same as that in the above embodiment. The description thereof will thus be omitted.

In this manner, at the arc start time, the feeding operation of the welding wire 2 is temporarily switched from the forward feeding to the backward feeding to stabilize the timing of arc generation and reduce the deformation of the welding wire 2 due to softening, thereby making it possible to reduce fusing.

### Fifth Variation

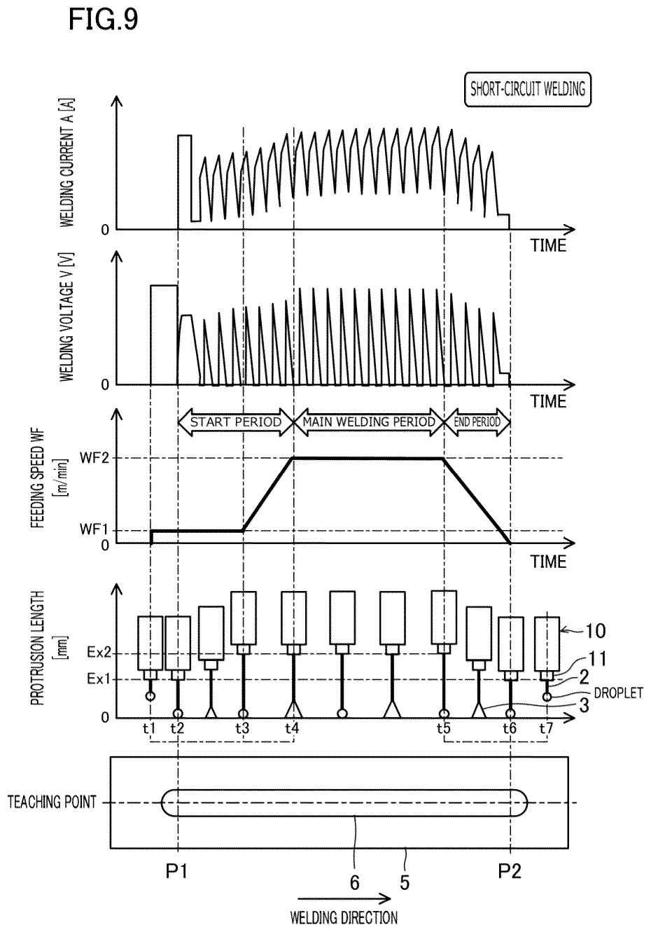

FIG. 9 is a diagram illustrating a current, a voltage, the waveform of a feeding speed, a protrusion length, and a teaching point in short-circuit welding. With respect to the waveform of FIG. 9, the vertical axis represents the welding current A, the welding voltage V, and the feeding speed WF, while the horizontal axis represents time.

In the short-circuit welding, the welding current A is controlled so that a short-circuit period and an arc period alternate. The short-circuit period is a short-circuit state in which the welding wire 2 and the welding target 5 are in contact with each other and short-circuited (the welding voltage is approximately OV). The arc period is an arc state in which the arc 3 occurs between the welding wire 2 and the welding target 5.

In the short-circuit period, the welding wire 2 and the welding target 5 are short-circuited. In the arc period, the arc 3 occurs between the welding wire 2 and the welding target 5. In the short-circuit welding, a welding current of 100 A as a peak current, for example, is applied to the welding wire 2.

In the arc period, an arc 3 is generated between the welding wire 2 and the welding target 5, and the heat of the arc 3 forms a droplet at the end of the welding wire 2 and melts part of the welding target 5.

At the point in time when the next short circuit occurs, the welding wire 2 and the welding target 5 come into contact with each other, and a short-circuit occurs, thereby causing short-circuit transfer of the droplet formed at the end of the welding wire 2 in the arc period to the welding target 5 and formation of a weld pool, and causing short-circuit welding.

In this manner, the short-circuit period and the arc period are alternated periodically in the short-circuit welding.

In the example shown in FIG. 9, the time point t1 is the point in time at which constant feeding of the welding wire 2 is started. The start period is a period from the time point t2 to the time point t4. The main welding period is a period from the time point t4 to a time point t5. The end period is a period from the time point t5 to a time point t6. The time point t7 indicates a state in which the protrusion length of the welding wire 2 is shortened after the end period.

The operation of the arc welding device 1 in the start period, the main welding period, and the end period is the same as that in the above embodiment. The description thereof will thus be omitted.

### Sixth Variation

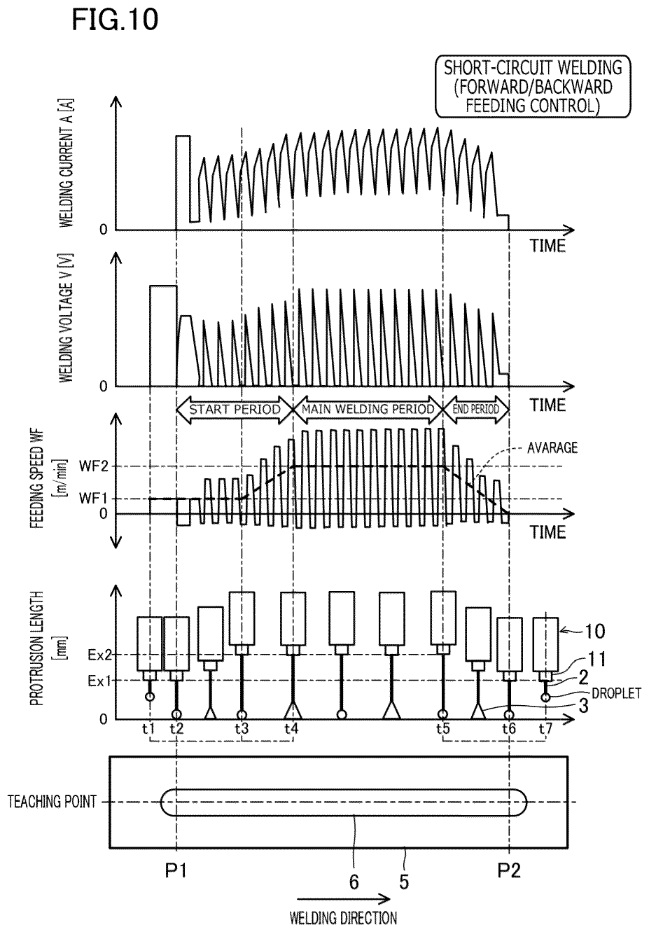

FIG. 10 is a diagram illustrating a current, a voltage, the waveform of a feeding speed, a protrusion length, and a teaching point in short-circuit welding under forward/backward feeding control. With respect to the waveform of FIG. 10, the vertical axis represents the welding current A, the welding voltage V, and the feeding speed WF, while the horizontal axis represents time.

In the example shown in FIG. 10, the time point t1 is the point in time at which constant feeding of the welding wire 2 is started. The start period is a period from the time point t2 to the time point t4. The main welding period is a period from the time point t4 to a time point t5. The end period is a period from the time point t5 to a time point t6. The time point t7 indicates a state in which the protrusion length of the welding wire 2 is shortened after the end period.

As shown in FIG. 10, the arc welding device 1 periodically alternates and repeats the forward feeding operation and the backward feeding operation of the welding wire 2 in the start period, the main welding period, and the end period.

As indicated by the dotted line in FIG. 10, in the start period, the average feeding speed of the welding wire 2 is set to the first feeding speed WF1 from the time point t2 to the time point t3. From the time point t3 to the time point t4, the average feeding speed of the welding wire 2 is set to gradually increase from the first feeding speed WF1 toward the second feeding speed WF2.

Here, the protrusion length of the welding wire 2 at the point in time when the end of the welding wire 2 comes into contact with the welding target 5, and a short-circuit occurs, immediately before the generation of an arc at the start of welding in the start period is shorter than the protrusion length of the welding wire 2 in the transition period that is a period of transition from the start period to the main welding period and in which the average feeding speed increases.

Accordingly, the weld pool is gradually formed and further increased in size in the start period; at the same time, the protrusion length of the welding wire 2 at the start of welding in the start period is increased after the time point t2 at which the end of the welding wire 2 comes into contact with the welding target 5 and a short-circuit occurs, so that the protrusion length can be increased, while reducing spatters, to the protrusion length Ex2 of the welding wire 2 in the main welding period, which is longer than the protrusion length Ex1 of the welding wire 2 at the start of welding in the start period (the time point t2 when the end of the welding wire 2 comes into contact with the welding target 5, and a short-circuit occurs). In this state, the period transitions to the main welding period.

Further, by gradually increasing the protrusion length of the welding wire 2 in the transition period (the start period) that is a period of transition from the start period to the main welding period and in which the average feeding speed increases, the welding amount of the welding wire 2 from before the main welding period is increased smoothly. It is thus possible to secure a stable, large welding amount and secure a stable, large welding amount from the start of the main welding period more reliably.

In the main welding period, the average feeding speed of the welding wire 2 is set to the second feeding speed WF2 from the time point t4 to the time point t5. In the end period, from the time point t5 to the time point t6, the average feeding speed of the welding wire 2 is set to gradually decrease from the second feeding speed WF2 toward the first feeding speed WF1.

The operation other than the wire feeding control of the arc welding device 1 in the start period, the main welding period, and the end period is the same as that in the above embodiment. The description thereof will thus be omitted.

### Other Embodiments

The embodiment described above may be modified as follows.

In this embodiment, the protrusion length of the welding wire 2 is gradually decreased in the end period so that the protrusion length of the welding wire 2 at the end of welding in the end period is equal to or shorter than the protrusion length of the welding wire 2 at the start of welding in the start period, but is not limited thereto.

For example, the welding wire 2 may be fed so that the protrusion length of the welding wire 2 at the end of welding in the end period is equal to the protrusion length of the welding wire 2 in the main welding period.

In this case, the welding wire 2 may be fed backward after the end of the end period so that the protrusion length of the welding wire 2 is equal to or shorter than the protrusion length of the welding wire 2 at the start of welding in the start period.

In this manner, setting the protrusion length of the welding wire 2 to be short by feeding the welding wire 2 backward after the end of welding in the end period can reduce problems, such as touch start, at the start of the next welding.

As described above, the present invention provides a highly practical advantage of stable arc start, while reducing the deformation of a welding wire, and is thus significantly useful and highly industrially applicable.

What is claimed is:

1. An arc welding method of welding a welding target by feeding a welding wire to the welding target and generating an arc between the welding wire and the welding target,
a welding period from start of welding to end of welding including a start period and a main welding period after the start period, the arc welding method comprising:
feeding the welding wire at a predetermined feeding speed in the start period;
generating the arc between the welding wire and the welding target after an end of the welding wire comes into contact with the welding target and a short-circuit occurs; and
feeding the welding wire in the main welding period at a higher feeding speed than the feeding speed in the start period,
a protrusion length of the welding wire at a point in time at which the end of the welding wire comes into contact with the welding target and a short-circuit occurs, immediately before the arc is generated at the start of welding in the start period being shorter than a protrusion length of the welding wire in the main welding period.

2. The arc welding method of claim 1, wherein
the protrusion length of the welding wire at the start of welding in the start period is 30% to 80% of the protrusion length of the welding wire in the main welding period.

3. The arc welding method of claim 1, wherein
the welding period includes an end period after the main welding period, and
the protrusion length of the welding wire at the end of welding in the end period is equal to or shorter than the protrusion length of the welding wire at the start of welding in the start period.

4. The arc welding method of claim 1, wherein
the welding period includes an end period after the main welding period, the arc welding method further comprising:
feeding the welding wire so that the protrusion length of the welding wire at the end of welding in the end period is equal to the protrusion length of the welding wire in the main welding period; and
feeding the welding wire backward after end of the end period so that the protrusion length of the welding wire is equal to or shorter than the protrusion length of the welding wire at the start of welding in the start period.

5. The arc welding method of claim 1, wherein
the welding target is made of a mild steel material or a material having a higher electrical resistance than a mild steel material.

6. The arc welding method of claim 1, wherein
the protrusion length of the welding wire at the point in time at which the end of the welding wire comes into contact with the welding target and a short-circuit occurs, immediately before the arc is generated at the start of welding in the start period is shorter than the protrusion length of the welding wire in a transition period that is a period of transition from the start period to the main welding period and in which a feeding speed or an average feeding speed increases.
